(19) United States
(12) Patent Application Publication
(10) Pub. No.: US 2011/0081098 A1
(43) Pub. Date: Apr. 7, 2011

(54) METHOD OF CORRECTING DISTORTION OF SCANNED IMAGE

(75) Inventors: Seong-ho CHO, Gwacheon-si (KR); Alexander GETMAN, Suwon-si (KR)

(73) Assignee: SAMSUNG ELECTRONICS CO., LTD., Suwon-si (KR)

(21) Appl. No.: 12/753,176

(22) Filed: Apr. 2, 2010

(30) Foreign Application Priority Data
Oct. 6, 2009 (KR) 10-2009-0094680

(51) Int. Cl. G06K 9/40

(52) U.S. Cl. 382/275

(57) ABSTRACT

A method of correcting distortion of a scanned image, the method including; providing a reference chip wherein positions of a plurality of spots and a gap region between the plurality of spots are defined, scanning the reference chip to obtaining a scanned image of the reference chip by scanning the reference chip, measuring distortion in the scanned image of the reference chip, preparing a biochip where a second plurality of spots are arrayed in a complementary form to the distortion and obtaining a scanned image of the biochip.

### CROSS-REFERENCE TO RELATED APPLICATION

This application claims priority to Korean Patent Application No. 10-2009-0094680, filed on Oct. 6, 2009, and all the benefits accruing therefrom under 35 U.S.C. §119, the content of which in its entirety is herein incorporated by reference.

### BACKGROUND

1. Field

The present disclosure relates to methods of correcting distortion of a scanned image, and more particularly, to methods of correcting distortion of a scanned biochip image so as to improve reliability of data extraction therefrom.

2. Description of the Related Art

A typical biochip is a biopsy device prepared in the form of a small chip such as a semiconductor chip, e.g., a micro-chip, by combining bioorganic materials including enzymes, proteins, deoxyribonucleic acid molecules (“DNA molecules”), microorganisms, cells, such as neural cells, and organs of animals and plants, and other similar materials. For example, a biochip may be formed by arraying several hundreds to several hundred thousand DNA molecules, each of which have different sequences, in a small space on a substrate which includes a glass or semiconductor material. Here, a group of single stranded DNA molecules having the same sequence is referred to as a spot, and in general, about 20 to about 30 bases of a DNA molecule may be ligated to form a single spot.

When a sample is flowed into the biochip, only a gene or protein within the sample which corresponds to a material of a certain spot is bound to the corresponding certain spot, e.g., a material in the sample may hybridize with a material of the certain spot, and genes or proteins that do not bind to spots on the biochip are washed out. Thus, it is easy to obtain bio-information relating to the sample by examining which spots on the biochip are bound to the sample. For example, unique expression or modification of genes, which is expressed in a certain cell or tissue, may be analyzed relatively quickly.

Various methods have been proposed to determine whether a spot on the biochip has bound to a material in the sample, and, if so, which spot in a biochip a material, such as a gene, is bound to. One of these methods is a fluorescent detection method. According to the fluorescent detection method, a sample is labeled with a fluorescent material which emits a specific color light when the sample is excited by an excitation light. Then, the sample is flowed into the biochip, and a fluorescent image obtained by illuminating the biochip with the excitation light is analyzed, so that it is possible to know which spot the sample is bound to by analyzing the obtained image. Alternatives to the fluorescent detection method include a chemiluminescent method which does not use fluorescence.

In general, a scanning apparatus for obtaining an optical image by illuminating the biochip with the excitation light sequentially scans the entire biochip in small units of about 1 μm through about 10 μm, and thus obtains a plurality of fluorescent images. Such a plurality of scanned fluorescent images may be analyzed in order to detect which spot in the biochip the sample is bound to.

### SUMMARY

Provided are methods of effectively correcting distortion of a scanned biochip image to improve reliability of data extraction according to optical detection.

Additional aspects will be set forth in part in the description which follows and, in part, will be apparent from the description, or may be learned by practice of the presented embodiments.

According to an embodiment of the present disclosure, a method of correcting distortion of a scanned image includes; providing a reference chip wherein positions of a plurality of spots and a gap region between the plurality of spots are defined, scanning the reference chip to obtain a scanned image of the reference chip, measuring distortion in the scanned image of the reference chip, preparing a biochip where a second plurality of spots are arrayed in a complementary form to the distortion, and obtaining a scanned image of the biochip.

In one embodiment, the reference chip may have an array of patterns which at least one of reflect and transmit light.

In one embodiment, the patterns may be arrayed in an even grid pattern.

In one embodiment, the operation of measuring the distortion may include; the comparing coordinates in the scanned image of the reference chip with coordinates on the reference chip, and obtaining a function which indicates the distortion using the compared coordinates.

In one embodiment, the function which indicates the distortion may be obtained by numerically determining at least one of a coefficient of an n^{th} order polynomial equation by comparing the coordinates in the scanned image of the reference chip with coordinates on the reference chip, wherein n is an integer≧0.

In one embodiment, the operation of preparing the biochip may include the operations of obtaining an inverse function of the function which indicates the distortion, applying the inverse function to the coordinates on the reference chip to transform the coordinates on the reference chip to obtain transformed coordinates, obtaining a complementary distortion pattern to the measured distortion using the transformed coordinates, and preparing a biochip having spots arrayed according to the complementary distortion pattern.

According to another aspect of the present disclosure, a method of correcting distortion of a scanned image includes; providing a reference chip wherein positions of a plurality of spots and a gap region between the plurality of spots are defined, scanning the reference chip to obtain a scanned image of the reference chip, measuring distortion in the scanned image of the reference chip, and transforming coordinate values in a spot position information file which indicates positions of spots in the scanned image according to the measured distortion, and obtaining a scanned image of a biochip using the transformed coordinate values.

In one embodiment, the operation of measuring the distortion may include; comparing coordinates in the scanned image of the reference chip with coordinates on the reference chip, and obtaining a function which indicates the distortion using the compared coordinates.

In one embodiment, the operation of transforming the coordinate values in the spot position information file may include the operation of transforming the coordinate values by applying the function which indicates the distortion to coordinate values in the spot position information file.

According to another aspect of the present disclosure, a method of correcting distortion of a scanned image includes; scanning a biochip to obtain a scanned image of the biochip, measuring coordinates of each of a plurality of spots in the scanned image of the biochip, determining a polynomial equation function to correct distortion of the scanned image of the biochip, determining coefficients of the polynomial equation function according to a magnitude and type of the distortion, and moving each spot in the scanned image according to the polynomial equation function with the determined coefficients to obtain a corrected image.

In one embodiment, the operation of determining the coefficients may include the operation of numerically determining polynomial term coefficients of an inverse function with respect to a function which indicates distortion.

In one embodiment, the operation of numerically determining the polynomial term coefficients may include the operation of adjusting the polynomial term coefficients until at least three spots on a row in the corrected image are aligned in a straight line.

In one embodiment, the operation of moving each spot in the scanned image according to the polynomial equation function with the determined coefficients may include; applying the polynomial equation function with the determined coefficients to coordinates of each spot in the scanned image to obtain transformed coordinates, moving each spot according to the transformed coordinates, and checking whether corrected distortion is within a tolerance range by checking the corrected image.

In one embodiment, when the checking whether the corrected distortion is within the tolerance range determines that the corrected distortion is not within the tolerance range, the method may further includes; measuring coordinates of each of a plurality of spots in the corrected image of the biochip, obtaining coordinates of each spot in the corrected image, determining new coefficients of the polynomial equation function according to a magnitude and type of the distortion, and moving each spot in the scanned image according to the polynomial equation function with the determined new coefficients, wherein the operations of measuring, determining, and moving are repeated until the corrected distortion is within the tolerance range.

In one embodiment, the operation of checking whether the corrected distortion is within the tolerance range may include the operation of checking whether at least three spots on a row in the corrected image are aligned in a straight line.

### BRIEF DESCRIPTION OF THE DRAWINGS

These and/or other aspects will become apparent and more readily appreciated from the following description of the embodiments, taken in conjunction with the accompanying drawings of which:

FIG. 1 schematically illustrates an embodiment of a structure of a fluorescence detector;

FIG. 2 is a diagram of an embodiment of a grid used in a gridding operation;

FIGS. 3A through 3D illustrate examples of distorted scanned images generated in the fluorescence detector of FIG. 1;

FIG. 3E is a diagram of an embodiment of an ideal image whose distortion is corrected;

FIG. 4 is a diagram of a grid which is modified by applying distortion thereto;

FIG. 5A illustrates an embodiment of an array status of spots in a biochip;

FIG. 5B illustrates an embodiment of an array status of spots in a distorted scanned image obtained by scanning the embodiment of a biochip of FIG. 5A; and

FIG. 6 is a flowchart of an embodiment of a correction method to obtain a scanned image whose distortion is corrected.

### DETAILED DESCRIPTION

Hereinafter, a method of correcting distortion of a scanned image will be described in detail with reference to the attached drawings. Embodiments now will be described more fully hereinafter with reference to the accompanying drawings, in which embodiments are shown. These embodiments may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the disclosure.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope thereof unless otherwise claimed. No language in the specification should be construed as indicating any non-claimed element as essential to the practice of the embodiments as used herein.

Hereinafter, the embodiments will be described in detail with reference to the accompanying drawings.

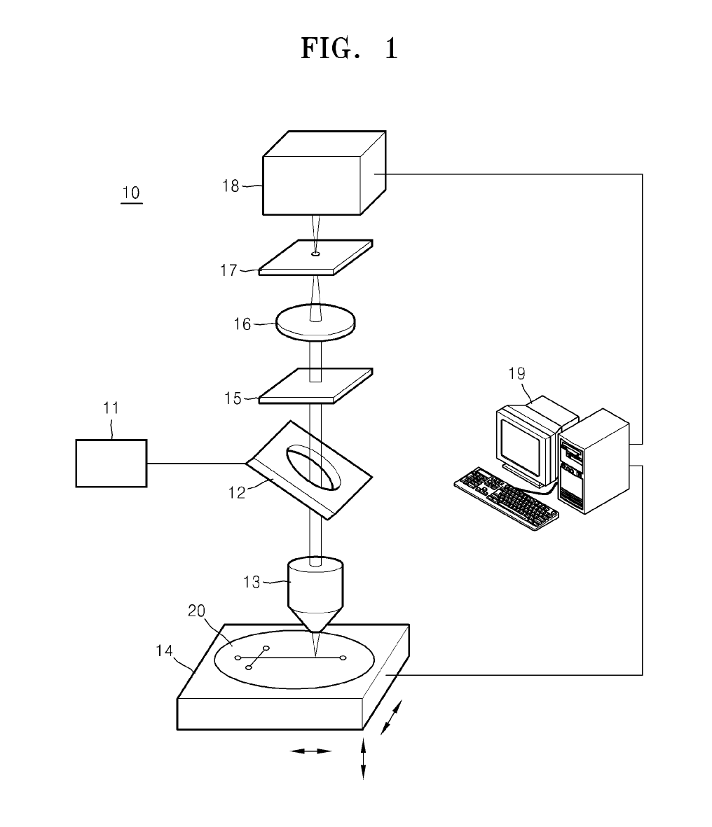

FIG. 1 schematically illustrates a structure of an embodiment of a fluorescence detector 10 for scanning a biochip 20 according to an embodiment of a fluorescent detection method. Referring to FIG. 1, the fluorescence detector 10 may include a light source 11 providing an excitation light for illuminating the biochip 20, a beam splitter 12 reflecting the excitation light toward the biochip 20, an objective lens 13 focusing the excitation light on the biochip 20, a stage 14 supporting the biochip 20 and moving the biochip 20 in either a vertical direction or a horizontal direction, or both, an excitation light absorbing filter 15 transmitting only fluorescence generated from the biochip 20, a lens 16 focusing the fluorescence, a pin hole 17 blocking an unnecessary optical component, e.g., extraneous light other than the fluorescence from the biochip 20, a detector 18 detecting the fluorescence generated from the biochip 20, and a control unit 19 analyzing an image of the biochip 20 which is detected by the detector 18, and optionally controlling movement of the stage 14.

Meanwhile, in an embodiment wherein another optical detection apparatus other than a fluorescence detection apparatus is used, e.g., self-luminescence devices, such as those including self-generated chemiluminescence, the light source 11 providing the excitation light may be excluded. In addition, if an optical path of the excitation light and an optical path of the fluorescence do not coincide in the fluorescence detector 10 of FIG. 1, the beam splitter 12 may be omitted. For example, in an embodiment wherein an inclined incident excitation light is introduced via an optical fiber, the fluorescence can be delivered to the detector 18 via another optical path.

In the structure of the fluorescence detector 10 illustrated in FIG. 1, the excitation light generated in the light source 11 is reflected by the beam splitter 12, and is focused on a certain predetermined region on the biochip 20. Then, a fluorescent material in a sample binding to certain spots in the certain region illuminated by the excitation light is excited so that fluorescence with a certain predetermined wavelength is generated. Such generated fluorescence passes through the beam splitter 12 and the excitation light absorbing filter 15, and is incident on the detector 18. After that, the detector 18, embodiments of which may include a charge coupled device (“CCD”) or a photomultiplier tube which has an array of a plurality of pixels, forms a scanned image with respect to the illuminated region, and provides the scanned image to the control unit 19. Then, the control unit 19 moves the biochip 20 via the stage 14, and obtains a scanned image of another predetermined region in the above-described manner.

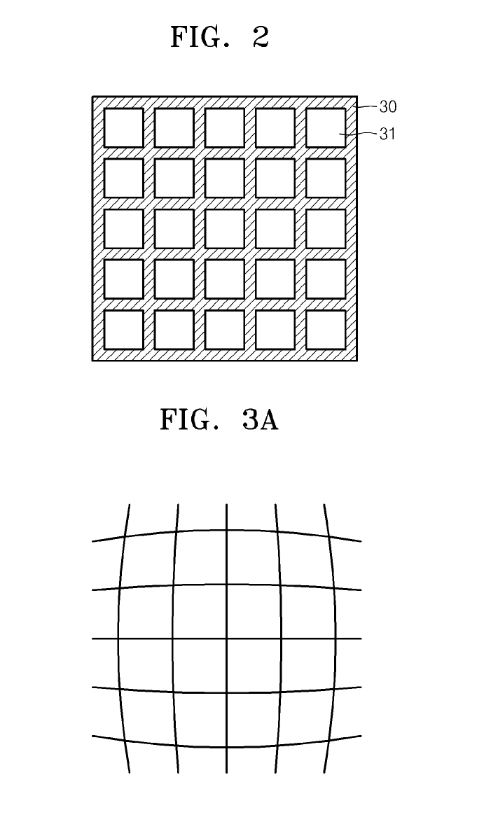

The control unit 19 performs a gridding operation on the scanned image, and thus extracts information about which spot is bound to the sample. Here, the gridding operation indicates an operation involving coordinating positions of spots in the scanned image and digitizing brightness of each spot by digitally expressing the brightness of each spot. In the gridding operation, in order to remove an unnecessary gap image between adjacent spots, and to correctly obtain spot images, a grid 30 illustrated in FIG. 2 is used. The grid 30 does not physically exist, and is a virtual logical means used by software in the control unit 19. Referring to FIG. 2, the grid 30 includes a plurality of grid regions 31. The grid 30 in FIG. 2 is an embodiment for use with quadrangle-shaped spots. However, in alternative embodiments wherein the spots are circular-shaped or polygonal-shaped, the grid regions 31 may also be circular-shaped or polygonal-shaped according to the shape of the spots. Alternative embodiments include configurations wherein the spots may have various other shapes.

When the gridding operation is performed on the grid 30 having the quadrangle-shaped grid regions 31, only necessary data may be extracted by exactly matching positions of spot images in the scanned image with positions of the grid regions 31. Accordingly, the grid 30 may be referred to as a position information file containing exact position coordinates of the spot images in a scanned biochip image. In addition, each of the grid regions 31 may be regarded as a region for obtaining information from a certain position in the scanned image. In FIG. 2, a total of 25 grid regions 31 are illustrated, but the embodiments are not limited thereto. In this regard, a large number of small grid regions 31 may exist in the control unit 19 in the form of an electronic file having coordinate values.

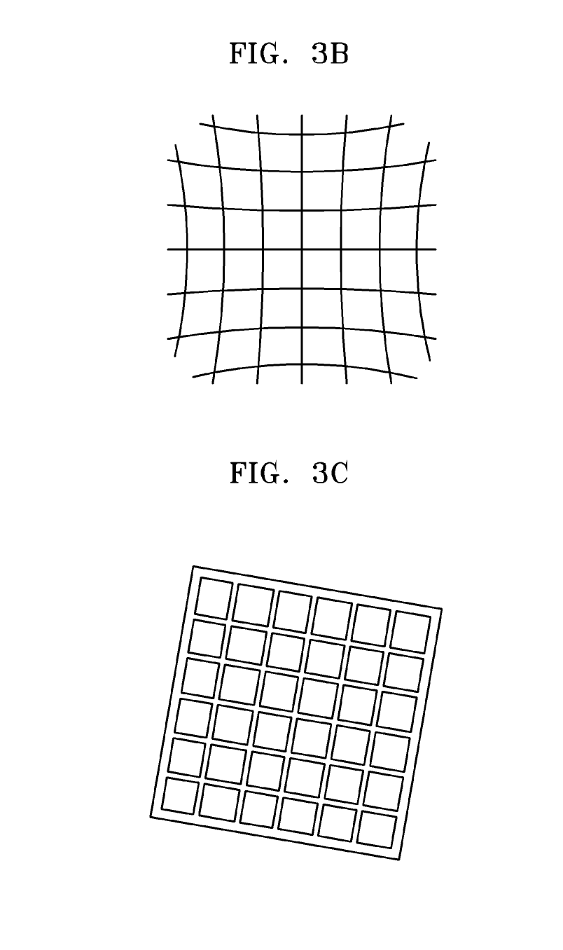

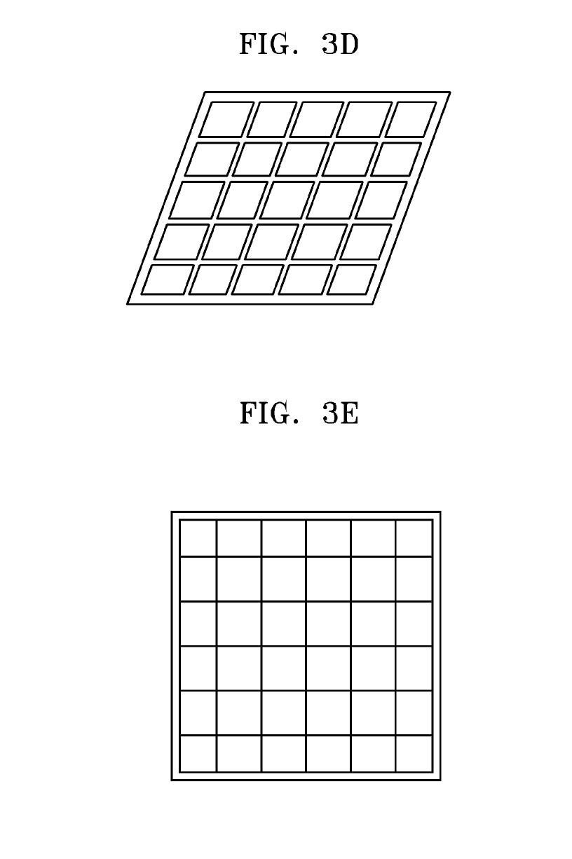

However, due to various aberrations of optical devices in the fluorescence detector 10, and possible alignment errors between the stage 14 and the detector 18, distortion may occur in the scanned image. FIGS. 3A through 3D illustrate examples of distorted scanned images. If the distortion exceeds a predetermined tolerance range, the positions of the spot images in the scanned image are not exactly matched with the positions of the grid regions 31, such that reliability of final data may be relatively low. Thus, when the distorted scanned image is corrected, as illustrated in FIG. 3E, the reliability of final data may be improved. Then, it is possible to make the spots on the biochip 20 smaller without lowering of reliability in the gridding operation. Therefore, if the spots on the biochip 20 may be made smaller, more testing may be performed for each biochip 20, thereby increasing the value of each biochip 20.

A method of precisely performing the gridding operation by correcting the distortion existing in the scanned image of the biochip 20 includes preparing the biochip 20 in consideration of such distortion. First, a reference chip is prepared in such a manner that positions of spots and a gap region constituting an empty space between the spots are well defined on the reference chip. The reference chip is configured such that distortion of the spots and the gap region is measurable. In one embodiment, an actual biomaterial including fluorescence labeled DNA or protein may be arrayed on the reference chip, or alternative embodiments include configurations wherein minute patterns reflecting or transmitting light may be arrayed on the reference chip. For example, in one embodiment the minute patterns may be arrayed in the form of an even grid pattern as illustrated in FIG. 3E.

After that, the reference chip is placed on the stage 14 of FIG. 1, and is scanned using the fluorescence detector 10 of FIG. 1 so that a scanned image of the reference chip is obtained. It is possible to measure a form and a level of distortion occurring in the fluorescence detector 10, via the scanned image. For example, if the scanned image has distortion in the form of a pincushion as illustrated in FIG. 3B, the biochip 20 is prepared in such a manner that spots are arrayed on the biochip 20 in a complementary manner to the distortion. For example, it is possible to design and prepare the biochip 20 in such a manner that the spots are arrayed on the biochip 20 in a manner as illustrated in FIG. 3A. Thus, the distortion in the fluorescence detector 10 transforms the image of the biochip so that the resulting image as detected by the fluorescent detector 10 has a regular, ordered appearance for gridding by the control unit 19.

In more detail, coordinates of minute patterns in a distorted scanned image are compared with coordinates of the minute patterns on the reference chip. Assuming that the coordinates of the minute patterns not having distortion are (x, y), and the coordinates of the minute patterns having the distortion are (x′, y′), functions f and g for obtaining (x′, y′) are shown in Equation 1 as follows.

[Equation 1]

x′=f(x, y) and

y′=g(x, y)

where functions f(x, y) and g(x, y) respectively indicate distortions of the image of the reference chip due to the fluorescence detector 10. The functions f(x, y) and g(x, y) may be obtained by comparing coordinates of the distorted minute patterns with coordinates of actual minute patterns on the reference chip itself and then by numerically determining a coefficient of an n^{th} order polynomial equation (where, n is an integer and n≧0). In one embodiment such a function may further include one or more of hyperbolic, parabola, exponential and trigonometric functions.

After the functions f(x, y) and g(x, y) are determined, their inverse functions, that is, f⁻¹(x, y) and g⁻¹(x, y) may be obtained. Inverse functions f⁻¹(x, y) and g⁻¹(x, y) are applied to the coordinates of the actual minute patterns, and thus the coordinates are transformed, thereby obtaining distortion complementary to measured distortion. For example, in the embodiment where the measured distortion has the form as illustrated in FIG. 3B, if the inverse functions f⁻¹(x, y) and g⁻¹(x, y) are applied to the coordinates of the actual minute patterns illustrated in FIG. 3E, a result thereof has the form as illustrated in FIG. 3A. The result that is a complementary pattern may be transferred to a photomask in a photolithography process, so that the biochip 20 may be prepared to have grid regions corresponding to the complementary pattern.

In the embodiment of a biochip 20 prepared according to the aforementioned manner, a plurality of spots is arrayed as illustrated in FIG. 3A. When the biochip 20 is scanned using the fluorescence detector 10, the distortion in the form as illustrated in FIG. 3B is applied to the scanned biochip image, so that a regularly spaced scanned image in the form as illustrated in FIG. 3E may be obtained. After that, the gridding operation may be easily performed using a general procedure. Essentially, the present embodiment images a regularly spaced reference chip and determines the amount and type of distortion in the image caused by imperfections in the optical system of the fluorescence detector. A biochip is then prepared having an irregular shape which has an inverse shape to that of the imaged reference chip, and thus when the biochip is imaged, it has a regularly spaced image due to the imperfections in the optical system of the fluorescence detector.

Another method of precisely performing the gridding operation by correcting the distortion existing in the scanned image of the biochip 20 is to modify the grid 30 from the form as illustrated in FIG. 2 to another shape. In order to perform this method, first, as described above, a reference chip is prepared in such a manner that positions of spots, and a gap region constituting an empty space between the spots are well defined in the reference chip such that distortion of the spots and the gap region is measurable. In this embodiment, the aforementioned description may be equally applied to the reference chip.

After the reference chip is prepared, as described above, the reference chip is placed on the stage 14 of FIG. 1, and is scanned using the fluorescence detector 10 of FIG. 1 so that a scanned image of the reference chip is obtained. It is possible to measure a form and a level of distortion occurring in the fluorescence detector 10 by checking the scanned image. Then, as described above, functions f(x, y) and g(x, y) respectively indicating distortions may be determined.

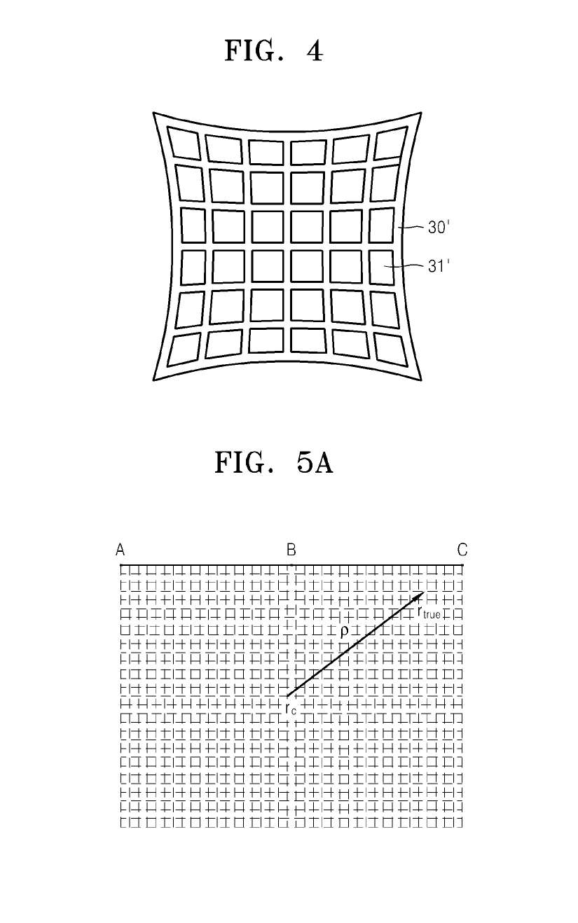

After that, by applying the functions f(x, y) and g(x, y) to the grid 30 illustrated in FIG. 2, wherein the grid 30 is simply a virtual logic construct of the control unit 19, a grid modified by applying distortion thereto is obtained. For example, when distortion in the form of a pincushion as illustrated in FIG. 3B occurs in the fluorescence detector 10, the grid 30 of FIG. 2 is transformed to a grid 30′ in the form as illustrated in FIG. 4, e.g., the grid 30 is transformed to have a shape corresponding to that of the distortion. Referring to FIG. 4, the transformed grid 30′ is also pincushion-shaped by applying the distortion thereto, and a plurality of grid regions 31′ in the grid 30′ are arrayed in the form of the pincushion. As described above, the grid 30 does not physically exist but exists in the form of an electronic file including coordinate values of the grid regions 31. Thus, an operation to generate the transformed grid 30′ includes obtaining coordinate values transformed by applying the functions f(x, y) and g(x, y) to coordinate values in the electronic file of the original grid 30.

The coordinate values of the grid regions 31′ in the transformed grid 30′ exactly indicate positions of spots in a distorted scanned image. Thus, when the biochip 20 is actually measured, it is not necessary to prepare a new biochip having complementary distortion, and the existing biochip 20 may be used. In this regard, when the gridding operation is performed in the control unit 19, the grid 30′ in the form of a spot position information file modified by applying the distortion thereto is used in order to properly align the grid 30′ and the existing biochip 20. Then, positions of spot images in a scanned image of the biochip 20 may be exactly matched with the positions of the grid regions 31′, so that only necessary data may be efficiently extracted.

The aforementioned examples involve measuring distortion in advance using the reference chip, and then modifying and using either the biochip 20 or the grid 30 by applying the measured distortion to either the biochip 20 or the grid 30. An alternative embodiment to be described in more detail below involves directly transforming a scanned image without using the reference chip, when the biochip 20 is actually measured. In the below described embodiment, since an ideal reference image to be compared with a distorted image so as to determine distortion does not exist, distortion is estimated in consideration of a form of a scanned image obtained from the actual measurement, and then the distortion is compensated for.

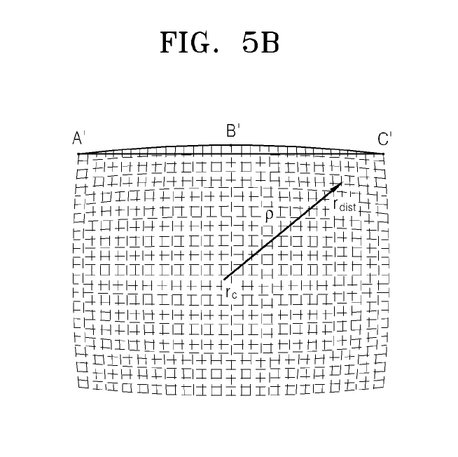

FIG. 5A illustrates an array status of spots in the biochip 20. If distortion as illustrated in FIG. 3A occurs in the fluorescence detector 10, a scanned image obtained by scanning the biochip 20 of FIG. 5A is illustrated in FIG. 5B. Referring to FIG. 5B, the spots in the scanned biochip image are arrayed in such a manner that center portions of four sides of the scanned biochip image are expanded, e.g., the center portions of all four sides are bowed outward from the center of the image. The distortion increases toward edges of the scanned image, and the least distortion occurs in the center of the scanned image. Thus, coordinates (x_{dist}, y_{dist}) of an arbitrary position r_{dist} at a distance from the center may be determined by referring to the center of the distorted scanned image as an origin r_{c}. In addition, coordinates of an actual position corresponding to the arbitrary position in the distorted scanned image may be expressed as (xₜᵣᵤₑ, yₜᵣᵤₑ). Then, a relationship between the actual coordinates (xₜᵣᵤₑ, yₜᵣᵤₑ) and the coordinates (x_{dist}, y_{dist}) in the distorted scanned image may be expressed by Equation 2.

[Equation 2]

x_{dist}=x_{c}+Pₙ(ρ)·(xₜᵣᵤₑ−x_{c}) and

y_{dist}=y_{c}+Pₙ(ρ)·(yₜᵣᵤₑ−y_{c})

where, x_{c} and y_{c} are coordinates of the origin r_{c}, ρ=\sqrt{(xₜᵣᵤₑ−x_{c})²+(yₜᵣᵤₑ−y_{c})²}, and Pₙ(ρ) is a function indicating the distortion and may be expressed by a polynomial equation Pₙ(ρ)=1+α₁·ρ+ . . . +αₙ·ρⁿ.

However, since the only coordinates obtained via measurement are the coordinates (x_{dist}, y_{dist}) of the arbitrary position in the distorted scanned image, the coordinates (x_{dist}, y_{dist}) are transformed into the actual coordinates (xₜᵣᵤₑ, yₜᵣᵤₑ) which are not distorted. Thus, Equation 2 may be transformed to Equation 3.

[Equation 3]

xₜᵣᵤₑ=x_{c}+Pₙ⁻¹(ρ)·(x_{dist}−x_{c}) and

yₜᵣᵤₑ=y_{c}+Pₙ⁻¹(ρ)·(y_{dist}−y_{c})

where, Pₙ⁻¹(ρ) is an inverse function of the function Pₙ(ρ) indicating the distortion.

Thus, when coefficients α₁˜αₙ of a polynomial equation with respect to Pₙ⁻¹(ρ) are obtained, a non-distorted actual image may be obtained by transforming the coordinates (x_{dist}, y_{dist}) in the distorted scanned image to the actual coordinates (xₜᵣᵤₑ, ₜᵣᵤₑ). Thus, all is needed to obtain the non-distorted actual image is the function Pₙ(ρ) indicating the distortion and the distorted image. itself An example for determining the coefficients α₁˜αₙ of the function Pₙ(ρ) indicating the distortion is to make three spots in one row to be aligned along a straight line. For example, referring to FIG. 5A, three spots A, B, C in an uppermost row on the biochip 20 that is not distorted are aligned in a straight line. On the other hand, referring to FIG. 5B, three spots A′, B′, C′ in an uppermost row on the distorted scanned image are not aligned in a straight line but instead lines between the three points form a triangle. Thus, the coefficients α₁˜αₙ are adjusted until new coordinates, which are transformed by applying the function Pₙ⁻¹(ρ) to the coordinates (x_{dist}, y_{dist}) of each of the three spots A′, B′, C′ in the distorted scanned image are aligned in a straight line. In one embodiment, this operation may be performed by a computer in the control unit 19. Meanwhile, only three spots are illustrated in each of FIGS. 5A and 5B; however, in order to increase accuracy of a correcting operation, alternative embodiments include configurations wherein a larger number of spots may be used.

When all the coordinates in the distorted scanned image are transformed, an image of the biochip 20 whose distortion is corrected may be obtained. Thus, in the present example, an array of the spots in the biochip 20 or an array of the grid regions 31 in the grid 30 is not transformed but a new image is generated by transforming all of a plurality of pixels in a scanned image. After that, the aforementioned gridding operation may be performed using the corrected image of the biochip 20.

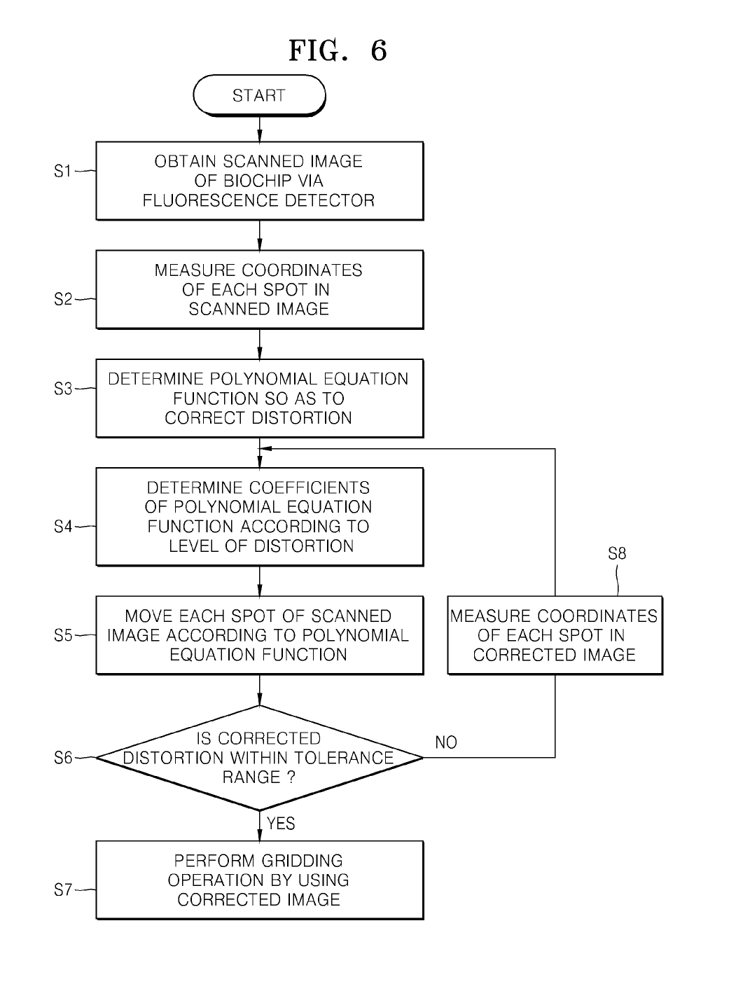

FIG. 6 is a flowchart of the correcting method described above. Referring to FIG. 6, as described above, a scanned image of the biochip 20 is obtained using the fluorescence detector 10 (operation S1). After that, the coordinates (x_{dist}, y_{dist}) of each spot in the scanned image are measured (operation S2). In order to correct distortion by moving the coordinates (x_{dist}, y_{dist}), the polynomial equation Pₙ(ρ)=1+α₁·ρ+ . . . +αₙ·ρⁿ is determined (operation S3). Here, the inverse function Pₙ⁻¹(ρ) in Equation 3 with respect to the polynomial equation function involves correcting the distortion.

Next, coefficients α₁˜αₙ of the polynomial equation with respect to Pₙ⁻¹(ρ) are determined according to a level of the distortion (operation S4). As described above, the determination of the coefficients α₁˜αₙ includes adjusting the coefficients α₁˜αₙ until new coordinates, which are transformed by applying the function Pₙ⁻¹(ρ) to the coordinates (x_{dist}, y_{dist}) of the three spots A′, B′, C′ in the distorted scanned image, are aligned in a straight line. When the coefficients α₁˜αₙ are determined, each spot in the distorted scanned image is moved to the new coordinates obtained using Equation 3 (operation S5).

After that, whether the corrected distortion is within a tolerance range suitable for the gridding operation is investigated by checking a distortion corrected image (operation S6). For example, whether the three spots A′, B′, and C′ in the distortion corrected image are aligned in a straight line, or whether coordinates of spots in the distortion corrected image match coordinates of grid regions in a grid may be checked. When it is determined that the distortion is sufficiently corrected, the gridding operation may be performed (operation S7). However, when the distortion is not sufficiently corrected, the coordinates of each spot in the distortion corrected image are measured again and obtained (operation S8) such that the aforementioned operations S4 and S5 may be repeated until the distortion is sufficiently corrected.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A method of correcting distortion of a scanned image, the method comprising:
providing a reference chip wherein positions of a plurality of spots and a gap region between the plurality of spots are defined;
scanning the reference chip to obtain a scanned image of the reference chip;
measuring distortion in the scanned image of the reference chip;
preparing a biochip where a second plurality of spots are arrayed in a complementary form to the distortion; and
obtaining a scanned image of the biochip.

2. The method of claim 1, wherein the reference chip has an array of patterns which at least one of reflect and transmit light.

3. The method of claim 2, wherein the patterns are arrayed in an even grid pattern.

4. The method of claim 1, wherein the measuring distortion comprises:
comparing coordinates in the scanned image of the reference chip with coordinates on the reference chip; and
obtaining a function which indicates the distortion using the compared coordinates.

5. The method of claim 4, wherein the function which indicates the distortion is obtained by numerically determining at least one coefficient of an n^{th} order polynomial equation by comparing the coordinates in the scanned image of the reference chip with coordinates on the reference chip, wherein n is an integer≧0.

6. The method of claim 4, wherein the preparing of the biochip comprises:
obtaining an inverse function of the function which indicates the distortion;
applying the inverse function to coordinates on the reference chip to transform the coordinates on the reference chip to obtain transformed coordinates;
obtaining a complementary distortion pattern to the measured distortion using the transformed coordinates; and
preparing a biochip having spots arrayed according to the complementary distortion pattern.

7. A method of correcting distortion of a scanned image, the method comprising:
providing a reference chip wherein positions of a plurality of spots and a gap region between the plurality of spots are defined;
scanning the reference chip to obtain a scanned image of the reference chip;
measuring distortion in the scanned image of the reference chip;
transforming coordinate values in a spot position information file which indicate positions of spots in the scanned image according to the measured distortion; and
obtaining a scanned image of a biochip using the transformed coordinate values.

8. The method of claim 7, wherein the reference chip has an array of patterns which at least one of reflect and transmit light.

9. The method of claim 7, wherein the measuring of the distortion comprises:
comparing coordinates in the scanned image of the reference chip with coordinates on the reference chip; and
obtaining a function which indicates the distortion using the compared coordinates.

10. The method of claim 9, wherein the transforming coordinate values in the spot position information file comprises transforming the coordinate values by applying the function which indicates the distortion to coordinate values to the spot position information file.

11. A method of correcting distortion of a scanned image, the method comprising:
scanning a biochip to obtain a scanned image of the biochip;
measuring coordinates of each of a plurality of spots in the scanned image of the biochip;
determining a polynomial equation function to correct distortion of the scanned image of the biochip;
determining coefficients of the polynomial equation function according to a magnitude and type of the distortion; and
moving each spot in the scanned image according to the polynomial equation function with the determined coefficients to obtain a corrected image.

12. The method of claim 11, wherein the determining coefficients comprises numerically determining polynomial term coefficients of an inverse function with respect to a function which indicates distortion.

13. The method of claim 12, wherein the numerically determining polynomial term coefficients comprises adjusting the polynomial term coefficients until at least three spots on a row in the corrected image are aligned in a straight line.

14. The method of claim 11, wherein the moving each spot in the scanned image according to the polynomial equation function with the determined coefficients comprises:
applying the polynomial equation function with the determined coefficients to coordinates of each spot in the scanned image to obtain transformed coordinates;
moving each spot according to the transformed coordinates; and
checking whether corrected distortion is within a tolerance range by checking the corrected image.

15. The method of claim 14, wherein, when the checking whether the corrected distortion is within the tolerance range determines that the corrected distortion is not within the tolerance range, the method further comprises;
measuring coordinates of each of a plurality of spots in the corrected image of the biochip;
obtaining coordinates of each spot in the corrected image;
determining new coefficients of the polynomial equation function according to a magnitude and type of the distortion; and
moving each spot in the scanned image according to the polynomial equation function with the determined new coefficients,
wherein the measuring, the determining, and the moving are repeated until the corrected distortion is within the tolerance range.

16. The method of claim 14, wherein the checking of whether the corrected distortion is within the tolerance range comprises checking whether at least three spots on a row in the corrected image are aligned in a straight line.
